(19) United States
(12) Patent Application Publication
(10) Pub. No.: US 2022/0013873 A1
(43) Pub. Date: Jan. 13, 2022

(54) SOLID-STATE BATTERY

(71) Applicant: Murata Manufacturing Co., Ltd., Nagaokayo-shi (KR)

(72) Inventors: Kiyoshi Kumagae, Nagaokayo-shi (JP); Takuya Matsuyama, Nagaokayo-shi (JP); Keisuke Shimizu, Nagaokayo-shi (JP)

(21) Appl. No.: 17/484,282

(22) Filed: Sep. 24, 2021

Related U.S. Application Data
(63) Continuation of application No. PCT/JP2020/005871, filed on Feb. 11, 2020.

(30) Foreign Application Priority Data
Mar. 26, 2019 (JP) 2019-058986

(51) Int. Cl. H01M 50/562; H01M 10/0525; H01M 10/0585; H01M 4/40; H01M 10/0562

(52) U.S. Cl. CPC H01M 50/562; H01M 10/0525; H01M 2004/027; H01M 4/405; H01M 10/0562; H01M 10/0585

(57) ABSTRACT

A solid-state battery that includes a solid-state battery laminate having at least one battery constituent unit in a lamination direction, the battery constituent unit including a positive electrode layer, a negative electrode layer, and a solid electrolyte layer interposed between the positive electrode layer and the negative electrode layer; a positive electrode terminal on a surface of the solid-state battery laminate; and a negative electrode terminal on the surface of the solid-state battery laminate. In addition, the negative electrode layer includes a negative electrode active material configured to be charged and discharged at a potential of −2 V or less with respect to a standard electrode potential, and the negative electrode terminal includes a terminal material that does not react with lithium ions at a potential of −3 V to −2 V with respect to the standard electrode potential.

### CROSS REFERENCE TO RELATED APPLICATIONS

The present application is a continuation of International application No. PCT/JP2020/005871, filed Feb. 14, 2020, which claims priority to Japanese Patent Application No. 2019-058986, filed Mar. 26, 2019, the entire contents of each of which are incorporated herein by reference.

### FIELD OF THE INVENTION

The present invention relates to a solid-state battery. More specifically, the present invention relates to a lithium ion solid-state battery.

### BACKGROUND OF THE INVENTION

Conventionally, a secondary battery that can be repeatedly charged and discharged has been widely used for various uses. For example, the secondary battery is used as a power source of an electronic device such as a smartphone or a notebook computer.

In the secondary battery, a liquid electrolyte is generally used as a medium for ion movement that contributes to charging and discharging. That is, a so-called electrolytic solution is used in the secondary battery. However, in such a secondary battery, safety is generally required from the viewpoint of preventing leakage of the electrolytic solution. In addition, since an organic solvent or the like used in the electrolytic solution is a flammable substance, safety is also required.

Therefore, studies on a solid-state battery using a solid electrolyte instead of an electrolytic solution have been conducted.
Patent Document 1: Japanese Patent Application Laid-Open No. 2015-220106

### SUMMARY OF THE INVENTION

A solid-state battery includes a solid-state battery laminate including a positive electrode layer, a negative electrode layer, and a solid electrolyte layer provided between the positive electrode layer and the negative electrode layer (see Patent Document 1). For example, as illustrated in FIG. 5, in a solid-state battery laminate 500′, a positive electrode layer 10A, a solid electrolyte layer 20, and a negative electrode layer 10B are sequentially laminated. The solid-state battery laminate 500′ is provided with a positive electrode terminal 30A and a negative electrode terminal 30B as external terminals, the positive electrode terminal 30A and the negative electrode terminal 30B being in contact with two side surfaces (that is, a positive electrode side end surface 500′A and a negative electrode side end surface 500′B) facing each other, respectively. Here, the positive electrode layer 10A and the negative electrode layer 10B extend so as to terminate at the positive electrode side end surface 500′A and the negative electrode side end surface 500′B, respectively.

The inventors of the present application realized that there are still issues to be overcome with the solid-state battery previously proposed as described above, and found a need to take measures for these issues. Specifically, the inventors of the present application found that there are the following problems.

A charge-discharge reaction of the solid-state battery can occur by conduction of ions between a positive electrode and a negative electrode through the solid electrolyte. In order to further increase an energy density of the battery, in the solid-state battery using for example lithium ions as such ions, a terminal material may cause a side reaction at a charge and discharge potential of the negative electrode depending on the terminal material used for the external terminal. Therefore, the lithium ions conducting between the electrodes are consumed, which may cause a decrease in battery capacity. Accordingly, the solid-state battery may not be preferred in terms of such a charge-discharge reaction.

The present invention has been made in view of such problems. That is, a main object of the present invention is to provide a solid-state battery that is more preferred in terms of a charge-discharge reaction when the solid-state battery uses lithium ions. Specifically, an object of the present invention is to provide a solid-state battery in which a side reaction between lithium ions and external terminals at a charge and discharge potential of a negative electrode can be suppressed and a decrease in battery capacity can be prevented.

The inventors of the present application have tried to solve the above problems by dealing with a new measure, rather than dealing with it as an extension of the related art. As a result, the invention of a lithium ion solid-state battery in which the above object has been achieved was completed.

In the present invention, there is provided is a lithium ion solid-state battery including: a solid-state battery laminate having at least one battery constituent unit in a lamination direction, the battery constituent unit including a positive electrode layer, a negative electrode layer, and a solid electrolyte layer interposed between the positive electrode layer and the negative electrode layer; a positive electrode terminal on a surface of the solid-state battery laminate and electrically connected to the positive electrode layer; and a negative electrode terminal on the surface of the solid-state battery laminate and electrically connected to the negative electrode layer, in which the negative electrode layer comprises a negative electrode active material configured to be charged and discharged at a potential of −2 V or less with respect to a standard electrode potential, and the negative electrode terminal comprises a terminal material that does not react with lithium ions at a potential of −3 V to −2 V with respect to the standard electrode potential.

The lithium ion solid-state battery according to an embodiment of the present invention is a solid-state battery that is preferred in terms of a charge-discharge reaction.

More specifically, in the lithium ion solid-state battery according to the present invention, a side reaction between lithium ions and external terminals at a charge and discharge potential of a negative electrode layer can be suppressed and a decrease in battery capacity can be prevented. Therefore, charge and discharge efficiency can be improved, and an energy density of the battery can be increased. In other words, battery deterioration can be suppressed in the long term view due to such a desired discharging, resulting in obtaining a lithium ion solid-state battery having improved long-term reliability.

### BRIEF EXPLANATION OF THE DRAWINGS

FIG. 1 illustrates results of linear sweep voltammetry evaluation in Example and Comparative Example of the present invention.

FIG. 2 illustrates a differential curve of a current value obtained using a potential as a parameter in the measurement results of linear sweep voltammetry in FIG. 1.

FIG. 3 is a sectional view schematically showing a lithium ion solid-state battery according to an embodiment of the present invention.

FIG. 4A to FIG. 4C are schematic sectional views for describing a method of producing a lithium ion solid-state battery according to an embodiment of the present invention.

FIG. 5 is a sectional view schematically showing a solid-state battery.

### DETAILED DESCRIPTION OF THE INVENTION

Hereinafter, a “lithium ion solid-state battery” of the present invention will be described in detail. Although the description is given with reference to the drawings, if necessary, the contents described are merely schematic and exemplified for understanding the present invention, and an appearance, a dimensional ratio, and the like can differ from the actual ones.

The “solid-state battery” used in the present invention refers to a battery whose constituent element is solid in a broad sense, and refers to an all-solid-state battery whose constituent element (in particular, preferably all constituent elements) is solid in a narrow sense. In a preferred aspect, the solid-state battery in the present invention is a laminate type solid-state battery configured such that layers constituting a battery constituent unit are laminated with each other. Each of the layers preferably is formed of a sintered body. Note that the “solid-state battery” includes not only a so-called “secondary battery” that can be repeatedly charged and discharged but also a “primary battery” that can be discharged only. In a preferred aspect of the present invention, the “solid-state battery” is a secondary battery. The “secondary battery” is not excessively limited by its name, and can include, for example, an electric storage device and the like. In addition, the “lithium ion solid-state battery” refers to a solid-state battery that is charged and discharged by movement of lithium ions between a positive electrode and a negative electrode.

The “section” used in the present specification is based on a form (directly, a form when cut out on a surface parallel to a thickness direction) when viewed from a direction substantially perpendicular to a thickness direction based on a lamination direction of each of the layers constituting the solid-state battery.

[Basic Configuration of Lithium Ion Solid-State Battery]

The lithium ion solid-state battery includes a solid-state battery laminate having at least one battery constituent unit in a lamination direction, the battery constituent unit including a positive electrode layer, a negative electrode layer, and a solid electrolyte layer interposed between the positive electrode layer and the negative electrode layer.

The lithium ion solid-state battery can be formed by firing each of the layers constituting the lithium ion solid-state battery, and the positive electrode layer, the negative electrode layer, the solid electrolyte layer, and the like may form a sintered layer. Preferably, the positive electrode layer, the negative electrode layer, and the solid electrolyte are integrally fired with each other, and thus, the battery constituent unit forms an integrally sintered body.

The positive electrode layer is an electrode layer formed of at least a positive electrode active material. The positive electrode layer may further include a solid electrolyte and/or a positive electrode current collector layer. In a preferred aspect, the positive electrode layer is formed of a sintered body including at least a positive electrode active material, solid electrolyte particles, and a positive electrode current collector layer. On the other hand, the negative electrode layer is an electrode layer formed of at least a negative electrode active material. The negative electrode layer may further include a solid electrolyte and/or a negative electrode current collector layer. In a preferred aspect, the negative electrode layer is formed of a sintered body including at least a negative electrode active material, solid electrolyte particles, and a negative electrode current collector layer.

The positive electrode active material and the negative electrode active material are materials involved in electron transfer in the solid-state battery. The movement (conduction) of ions between the positive electrode layer and the negative electrode layer through the solid electrolyte and the electron transfer between the positive electrode layer and the negative electrode layer through an external circuit are performed, such that charging and discharging are performed. The positive electrode layer and the negative electrode layer are layers that can occlude and release lithium ions. In a preferred aspect, there is provided a solid-state secondary battery in which lithium ions move between a positive electrode layer and a negative electrode layer through a solid electrolyte to charge and discharge the battery.

(Positive Electrode Active Material)

The positive electrode active material contained in the positive electrode layer is, for example, a lithium-containing compound. The kind of the lithium-containing compound is not particularly limited, and examples thereof include a lithium transition metal composite oxide and a lithium transition metal phosphate compound. The positive electrode active material may be a transition metal halide. The lithium transition metal composite oxide is a generic term for an oxide containing lithium and one kind or two or more kinds of transition metal elements as constituent elements. The lithium transition metal phosphate compound is a generic term for a phosphate compound containing lithium and one kind or two or more kinds of transition metal elements as constituent elements. In addition, the transition metal halide is a generic term for a halide containing one kind or two or more kinds of transition metal elements as constituent elements. The kind of the transition metal element is not particularly limited, and examples thereof include cobalt (Co), nickel (Ni), vanadium (V), chromium (Cr), manganese (Mn), and iron (Fe).

The lithium transition metal composite oxide is, for example, a compound represented by each of LiₓM1O₂ and Li_{y}M2O₄, or the like. The lithium transition metal phosphate compound is, for example, a compound represented by Li_{z}M3PO₄, or the like. However, each of M1, M2, and M3 is one kind or two or more kinds of transition metal elements. The respective values of x, y, and z are arbitrary (where, it is not zero (0)).

Specifically, the lithium transition metal composite oxide is, for example, LiCoO₂, LiNiO₂, LiVO₂, LiCrO₂, LiMn₂O₄, or the like. The lithium transition metal phosphate compound is, for example, LiFePO₄, LiCoPO₄, or the like. In addition, the transition metal halide is, for example, FeF₃, CoF₃, or the like.

(Negative Electrode Active Material)

The negative electrode active material contained in the negative electrode layer is, for example, a carbon material, a metal-based material, a lithium alloy, or the like.

Specifically, the carbon material is, for example, graphite, easily graphitizable carbon, non-graphitizable carbon, mesocarbon microbeads (MCMB), highly oriented graphite (HOPG), or the like.

The metal-based material is a generic term for a material containing one kind or two or more kinds of metal elements and metalloid elements that can form an alloy with lithium as constituent elements. The metal-based material may be a simple material, an alloy (for example, a lithium alloy), or a compound. Since a purity of the simple material described herein is not necessarily limited to 100%, the single material may contain a trace amount of impurities.

The metal element or the metalloid element is, for example, silicon (Si), tin (Sn), aluminum (Al), indium (In), magnesium (Mg), boron (B), gallium (Ga), germanium (Ge), lead (Pb), bismuth (Bi), cadmium (Cd), titanium (Ti), chromium (Cr), iron (Fe), niobium (Nb), molybdenum (Mo), silver (Ag), zinc (Zn), hafnium (Hf), zirconium (Zr), yttrium (Y), palladium (Pd), platinum (Pt), or the like.

Specifically, the metal-based material is, for example, Si, Sn, SiB₄, TiSi₂, SiC, Si₃N₄, SiOᵥ (0<v≤2), LiSiO, SnO_{w} (0<w≤2), SnSiO₃, LiSnO, Mg₂Sn, or the like.

Note that the positive electrode layer and/or the negative electrode layer may contain an electron conductive material. Examples of the electron conductive material that can be contained in the positive electrode layer and/or the negative electrode layer include a carbon material and a metallic material. Specifically, the carbon material is, for example, graphite, carbon nanotube, or the like. The metallic material is, for example, copper (Cu), magnesium (Mg), titanium (Ti), iron (Fe), cobalt (Co), nickel (Ni), zinc (Zn), aluminum (Al), germanium (Ge), indium (In), gold (Au), platinum (Pt), silver (Ag), palladium (Pd), or the like, and may be an alloy of two or more thereof.

In addition, the positive electrode layer and/or the negative electrode layer may contain a binder. The binder is, for example, one kind or two or more kinds of synthetic rubber, a polymer material, and the like. Specifically, the synthetic rubber is, for example, styrene butadiene-based rubber, fluorine-based rubber, ethylene propylene diene, or the like. Examples of the polymer material include at least one selected from the group consisting of polyvinylidene fluoride, polyimide, and an acrylic resin.

Further, the positive electrode layer and/or the negative electrode layer may contain a sintering aid. Examples of the sintering aid include at least one selected from the group consisting of lithium oxide, sodium oxide, potassium oxide, boron oxide, silicon oxide, bismuth oxide, and phosphorus oxide.

A thickness of each of the positive electrode layer and the negative electrode layer is not particularly limited, and may be independently, for example, 2 μm to 100 μm, and particularly, 5 μm to 50 μm.

(Solid Electrolyte)

The solid electrolyte is, for example, a material through which lithium ions can be conducted. In particular, the solid electrolyte constituting the battery constituent unit in the solid-state battery forms a layer through which, for example, lithium ions can be conducted between the positive electrode layer and the negative electrode layer. Note that the solid electrolyte may be provided at least between the positive electrode layer and the negative electrode layer. That is, the solid electrolyte may be present around the positive electrode layer and/or the negative electrode layer so as to protrude from a space between the positive electrode layer and the negative electrode layer. Examples of a specific solid electrolyte include one kind or two or more kinds of crystalline solid electrolytes and glass ceramic-based solid electrolytes.

The crystalline solid electrolyte is, for example, an inorganic material, a polymer material, or the like, and the inorganic material is, for example, a sulfide, an oxide, phosphorus oxide, or the like. The sulfide is, for example, Li₂S—P₂S₅, Li₂S—SiS₂—Li₃PO₄, Li₇P₃S₁₁, Li_{3.25}Ge_{0.25}P_{0.75}S, Li₁₀GeP₂S₁₂, or the like. The oxide or the phosphorus oxide is, for example, LiₓM_{y}(PO₄)₃ (1≤x≤2, 1≤y≤2, and M is at least one selected from the group consisting of Ti, Ge, Al, Ga, and Zr), Li₇La₃Zr₂O₁₂, Li_{6.75}La₃Zr_{1.75}Nb_{0.25}O₁₂, Li₆BaLa₂Ta₂O₁₂, Li₁₊ₓAlₓTi₂₋ₓ(PO₄)₃, La_{2/3-x}Li₃ₓTiO₃, Li_{1.2}Al_{0.2}Ti_{1.8}(PO₄)₃, La_{0.55}Li_{0.35}TiO₃, Li₇La₃Zr₂O₁₂, or the like. The polymer material is, for example, polyethylene oxide (PEO) or the like.

The glass ceramic-based solid electrolyte is an electrolyte in which amorphous and crystalline phases are mixed with each other. The glass ceramic-based solid electrolyte contains, for example, at least two selected from the group consisting of lithium (Li), silicon (Si), phosphorus (P), and boron (B). More specifically, the glass ceramic-based solid electrolyte contains lithium oxide (Li₂O), silicon oxide (SiO₂), boron oxide (B₂O₃), and the like. A ratio of a content of the lithium oxide with respect to a total content of the lithium oxide, the silicon oxide, and the boron oxide is not particularly limited, and is, for example, 40 mol % to 73 mol %. A ratio of a content of the silicon oxide with respect to the total content of the lithium oxide, the silicon oxide, and the boron oxide is not particularly limited, and is, for example, 8 mol % to 40 mol %. A ratio of a content of the boron oxide with respect to the total content of the lithium oxide, the silicon oxide, and the boron oxide is not particularly limited, and is, for example, 10 mol % to 50 mol %. In order to measure the content of each of the lithium oxide, the silicon oxide, and the boron oxide, the glass ceramic-based solid electrolyte is analyzed using, for example, inductively coupled plasma-atomic emission spectroscopy (ICP-AES) or the like.

The solid electrolyte layer may contain a binder and/or a sintering aid. The binder and/or the sintering aid that can be contained in the solid electrolyte layer may be selected from, for example, the same material as that of the binder and/or the sintering aid that can be contained in the positive electrode layer and/or the negative electrode layer.

A thickness of the solid electrolyte layer is not particularly limited, and may be, for example, 1 μm to 15 μm, and particularly, 1 μm to 5 μm.

(Positive Electrode Current Collector Layer/Negative Electrode Current Collector Layer)

As a positive electrode current collector constituting the positive electrode current collector layer or a negative electrode current collector constituting the negative electrode current collector layer, a material having a high conductivity is preferably used. For example, it is preferable to use at least one selected from the group consisting of a carbon material, silver, palladium, gold, platinum, aluminum, copper, and nickel. Each of the positive electrode current collector layer and the negative electrode current collector layer may have an electrical connection portion for being electrically connected to the outside, and may be configured to be electrically connected to the terminal. Each of the positive electrode current collector layer and the negative electrode current collector layer may have a form of a foil, and preferably has an integrally sintered form from the viewpoint of improving an electron conductivity by integral sintering and reducing a production cost. Note that in a case where each of the positive electrode current collector layer and the negative electrode current collector layer has a form of a sintered body, each of the positive electrode current collector layer and the negative electrode current collector layer may be formed of a sintered body containing an electron conductive material, a binder, and/or a sintering aid. The electron conductive material that can be contained in the positive electrode current collector layer and the negative electrode current collector layer may be selected from, for example, the same material as that of the electron conductive material that can be contained in the positive electrode layer and/or the negative electrode layer. The binder and/or the sintering aid that can be contained in the positive electrode current collector layer and the negative electrode current collector layer may be selected from, for example, the same material as that of the binder and/or the sintering aid that can be contained in the positive electrode layer and/or the negative electrode layer.

A thickness of each of the positive electrode current collector layer and the negative electrode current collector layer is not particularly limited, and may be independently, for example, 1 μm to 10 μm, and particularly, 1 μm to 5 μm.

(Insulating Layer)

An insulating layer refers to a layer that can be formed of a material that does not conduct electricity, that is, a non-conductive material in a broad sense, and refers to a material that can be formed of an insulating material in a narrow sense. Although not particularly limited, the insulating layer may be formed of, for example, a glass material, a ceramic material, or the like. For example, a glass material may be selected as the insulating layer. Although not particularly limited, an example of the glass material includes at least one selected from the group consisting of soda-lime glass, potash glass, borate glass, borosilicate glass, barium borosilicate glass, zinc borate glass, barium borate glass, bismuth borate glass, bismuth zinc borate glass, bismuth borosilicate glass, phosphate glass, aluminophosphate glass, and zinc phosphate glass. In addition, although not particularly limited, an example of the ceramic material includes at least one selected from the group consisting of aluminum oxide (Al₂O₃), boron nitride (BN), silicon dioxide (SiO₂), silicon nitride (Si₃N₄), zirconium oxide (ZrO₂), aluminum nitride (AlN), silicon carbide (SiC), and barium titanate (BaTiO₃).

(Protective Layer)

A protective layer is generally a layer that can be formed on the outermost side of the solid-state battery, and is a layer for electrically, physically, and/or chemically protecting the solid-state battery, particularly for protecting the solid-state battery laminate. A material that can form the protective layer is preferably a material that is excellent in insulating properties, durability, and/or moisture resistance and is environmentally safe. For example, it is preferable to use glass, ceramics, a thermosetting resin, and/or a photocurable resin.

(External Terminal)

In general, the solid-state battery may be provided with an external terminal. Such an external terminal may be provided on at least one surface of the solid-state battery laminate. For example, external terminals of the positive and negative electrodes may be provided on the same surface in the solid-state battery laminate so as to be separated from each other. Alternatively, the external terminals of the positive and negative electrodes may be provided on side surfaces of the solid-state battery laminate, respectively, so as to face each other. Specifically, the external terminal on the positive electrode side, which is connected to the positive electrode layer (that is, a positive electrode terminal) and the external terminal on the negative electrode side, which is connected to the negative electrode layer (that is, a negative electrode terminal) may be provided so as to face each other. Although not particularly limited, an example of a material for the terminal includes at least one selected from the group consisting of gold, silver, platinum, tin, nickel, copper, manganese, cobalt, iron, titanium, and chromium.

[Characteristics of Lithium Ion Solid-State Battery of the Present Invention]

The lithium ion solid-state battery of the present invention is a lithium ion solid-state battery including: at least one battery constituent unit in a lamination direction, the battery constituent unit including a positive electrode layer, a negative electrode layer, and a solid electrolyte layer interposed between the positive electrode layer and the negative electrode layer; and a positive electrode terminal and a negative electrode terminal each provided on at least one surface of a solid-state battery laminate. The lithium ion solid-state battery of the present invention is characterized in terms of materials of the negative electrode layer and the negative electrode terminal.

More specifically, the lithium ion solid-state battery of the present invention is a solid-state battery using lithium ions, in which the negative electrode layer is formed of a negative electrode active material that is configured to be charged and discharged at a potential of −2 V or less with respect to a standard electrode potential, and the negative electrode terminal is formed of a terminal material that does not react with lithium ions at a potential of −3 V to −2 V with respect to the standard electrode potential.

The “terminal material that does not react with lithium ions at a potential of −3 V to −2 V with respect to the standard electrode potential” used in the present specification refers to a material that does not cause an irreversible side reaction (for example, a reduction reaction) between lithium ions at a potential of −3 V to −2 V with respect to the standard electrode potential in a broad sense. Specifically, the terminal material refers to a material that does not react with lithium ions to be alloyed.

In a narrow sense, it refers to a material in which a ratio of an average of first differential values at −3 V to −2 V to an average of second differential values at −2 V to −1 V is 8.0 or less, the differential value being a differential value of a current value obtained by linear sweep voltammetry measurement using the terminal material and lithium as a working electrode and a reference electrode, respectively, and using a potential with respect to a standard electrode potential as a parameter. As for the current value obtained by the linear sweep voltammetry measurement of the terminal material, any one of a current curve of a reduction wave obtained by sweeping the potential in a negative direction and a current curve of an oxidation wave obtained by sweeping the potential in a positive direction may satisfy the above, and it is preferable that both the current curves satisfy the above.

When the ratio is 8.0 or less, a current other than a current caused by an oxidation reduction reaction of a capacitor component (that is, an oxidation current and/or a reduction current) is less likely to be generated. That is, a side reaction occurring between the terminal materials and the lithium ions can be more reversible at the potential of −3 V to −2 V with respect to the standard electrode potential. The ratio is preferably 6.0 or less, more preferably 4.0 or less, and still more preferably 2.0 or less.

The “current value obtained by linear sweep voltammetry measurement using a potential as a parameter” used in the present specification refers to a measured value obtained using a measuring apparatus such as Potentiostat/Galvanostat: model 1287 (manufactured by Solartron Metrology Ltd.). A measurement procedure (evaluation method) and measurement conditions in the measurement are described in detail as follows.

[Measurement Procedure (Evaluation Method)]

(1) First, a Measurement Cell is Assembled as Follows.

A sintered body for a solid electrolyte is prepared, and a working electrode is formed on one surface of the sintered body (for example, a paste of a working electrode material is applied and heat-cured at a predetermined temperature). Next, a counter electrode is formed on one surface of a solid electrolyte sintered body (for example, a counter electrode material is thermally pressure-bonded at a predetermined temperature). In the same procedure, a reference electrode is formed on the same surface of the solid electrolyte sintered body on which the working electrode is formed so as not to be in contact with the working electrode (for example, a reference electrode material is thermally pressure-bonded at a predetermined temperature).

(2) Next, a terminal of the measuring apparatus is connected to the working electrode, the counter electrode, and the reference electrode.

(3) The measurement is performed under the following conditions.

[Measurement Conditions]
Working electrode area: diameter of 6 mm
Reference electrode area: diameter of 1 mm
Counter electrode area: diameter of 10 mm
Scanning potential: 3 V to 0.05 V (0.05 V to −3 V vs. SHE)
Sweep rate: 0.2 mV/sec
Measurement temperature: room temperature (about 25° C.)

The “differential value of the current value obtained using a potential as a parameter” used in the present specification may refer to a value calculated by differentiating the current value at each potential obtained by the above-described measurement according to the following Equation 1. In Equation 1, f(a) represents a current value at a potential a (V), and f′(a) represents a differential value of a current value at the potential a (V). ΔV represents a potential difference between the measurement point and another arbitrary measurement point at the potential a (V). ΔV may be 10E⁻¹⁰ to 1.0 (V). For example, ΔV may be 0.5 (V). f(a+ΔV) represents a current value when the potential difference ΔV is added to the potential a (V). The differential value may be calculated at a potential interval of 0.001 V to 0.5 V. For example, the differential value may be calculated for each potential of 0.25 V. The differential value calculated as described above may be obtained by calculating each of an average of differential values at −2 V to −1 V and an average of differential values at −3 V to −2 V, with respect to the standard electrode potential.

$${f}^{′} ( i ) = \frac{f ( a + Δ V ) - f ( a )}{Δ V} \qquad Equation 1$$

In the solid-state battery of the present invention, the negative electrode terminal is formed of the terminal material as described above, such that a solid-state battery that is more desirable in terms of a charge-discharge reaction is obtained. In particular, it is possible to suppress a side reaction between the lithium ions and the external terminals at a charge and discharge potential of the negative electrode layer and to prevent a decrease in battery capacity. Therefore, charge and discharge efficiency can be improved, and an energy density of the battery can be increased. In other words, battery deterioration can be suppressed in the long term view due to such a desired discharging, resulting in obtaining a solid-state battery having improved long-term reliability.

In a preferred aspect, the negative electrode terminal is formed of a terminal material that does not react with lithium ions at a potential of −3 V to −2 V with respect to a standard electrode potential (for example, nickel, copper, or the like) and a metallic material having a conductivity relatively higher than that of the terminal material (for example, silver or the like), and the terminal material is positioned on a side of the negative electrode terminal that is in contact with the solid-state battery laminate.

In another preferred aspect, the negative electrode terminal is formed of a terminal material that does not react with lithium ions at a potential of −3 V to −2 V with respect to a standard electrode potential (for example, nickel, copper, or the like) and particles formed of a metallic material having a conductivity relatively higher than that of the terminal material (for example, silver or the like), and the terminal material is positioned on surfaces of the particles.

With the above configuration, it is possible to suppress a side reaction between the external terminals and the lithium ions and to prevent a decrease in battery capacity while maintaining a high conductivity of the external terminal.

Since the lithium ions hardly react with an element in which electrons are present in 3d orbital and the outermost electrons are present in 4s orbital, the negative electrode terminal is preferably formed of a metal element having such electron orbitals. Although not intended to be restricted to a specific theory, it is considered that each reaction is suppressed due to a preferred combinational compatibility of the lithium ions and the above elements. In a preferred aspect, the negative electrode terminal is formed of at least one element selected from the group consisting of nickel, copper, iron, manganese, cobalt, titanium, and chromium. In other words, the terminal material that does not react with lithium ions at a potential of −3 V to −2 with respect to a standard electrode potential is preferably a material containing at least one material selected from the group consisting of nickel, copper, iron, manganese, cobalt, titanium, and chromium. The terminal material may contain a combination of a plurality of elements or may be a material alloyed with a plurality of elements. The terminal material contains such elements, such that a side reaction between the lithium ions and the external terminals can be more efficiently suppressed, and a decrease in battery capacity can be prevented.

In a preferred aspect, the negative electrode active material contains graphite and/or a lithium alloy. The negative electrode active material contains such a material such that the negative electrode layer can be more efficiently charged and discharged at a potential of −2 V or less with respect to the standard electrode potential. Therefore, an energy density of the battery can be further increased.

In a preferred aspect, the solid electrolyte layer contains at least two selected from the group consisting of lithium, boron, silicon, phosphorus, and oxygen. The solid electrolyte layer contains such an element such that the lithium ions can be more efficiently conducted. Therefore, the charge and discharge efficiency of the solid-state battery can be more improved.

The solid-state battery according to the present invention is a laminate type solid-state battery in which layers constituting a battery constituent unit are laminated, and can be produced by a printing method such as a screen printing method, a green sheet method using a green sheet, or a composite method thereof. Therefore, each of the layers constituting the battery constituent unit may be formed of a sintered body. Preferably, the positive electrode layer, the negative electrode layer, and the solid electrolyte layer are integrally sintered with each other. That is, it is considered that the solid-state battery laminate forms a fired integrated product. Such a fired integrated product preferably includes a positive electrode terminal and a negative electrode terminal each provided on a side surface so as to face each other, and the negative electrode terminal is formed of a terminal material that does not react with lithium ions at a potential of −3 V to −2 V with respect to a standard electrode potential.

The solid-state battery may further include a protective layer. As illustrated in FIG. 3, in a solid-state battery 500, a protective layer 40 may be provided outside of a solid-state battery laminate 500′, a positive electrode terminal 30A, and a negative electrode terminal 30B so as to be integrated with them.

[Method of Producing Solid-State Battery]

As described above, the solid-state battery of the present invention can be produced by a printing method such as a screen printing method, a green sheet method using a green sheet, or a composite method thereof. Hereinafter, a case where a printing method or a green sheet method is adopted will be described in detail for understanding the present invention, but the present invention may not be limited to these methods.

(Step of Forming Solid-State Battery Laminate Precursor)

In the present step, several types of pastes such as a paste for a positive electrode layer, a paste for a negative electrode layer, a paste for a solid electrolyte layer, a paste for a current collector layer, a paste for an insulating layer (a paste for an electrode separation part), and a paste for a protective layer are used as ink. That is, a paste having a predetermined structure is formed or laminated on a support substrate by applying the paste by a printing method.

In the printing, a solid-state battery laminate precursor corresponding to a predetermined solid-state battery structure can be formed on a substrate by sequentially laminating print layers into a predetermined thickness and pattern. A method of forming the pattern is not particularly limited as long as it is a method capable of forming a predetermined pattern, and is, for example, one kind or two or more of a screen printing method and a gravure printing method.

The paste can be prepared by wet-mixing a predetermined constituent material for each layer appropriately selected from the group consisting of a positive electrode active material, a negative electrode active material, an electron conductive material, a solid electrolyte material, a current collector layer material, an insulating material, a binder, and a sintering aid, and an organic vehicle in which an organic material is dissolved in a solvent. The paste for a positive electrode layer contains, for example, a positive electrode active material, an electron conductive material, a solid electrolyte material, a binder, a sintering aid, an organic material, and a solvent. The paste for a negative electrode layer contains, for example, a negative electrode active material, an electron conductive material, a solid electrolyte material, a binder, a sintering aid, an organic material, and a solvent.

Here, the negative electrode active material contains, for example, at least one selected from the group consisting of graphite, a lithium alloy, and a lithium-containing compound. The paste for a solid electrolyte layer contains, for example, a solid electrolyte material, a binder, a sintering aid, an organic material, and a solvent. Each of the paste for a positive electrode current collector layer and the paste for a negative electrode current collector layer contains an electron conductive material, a binder, a sintering aid, an organic material, and a solvent. The paste for a protective layer contains, for example, an insulating material, a binder, an organic material, and a solvent. The paste for an insulating layer contains, for example, an insulating material, a binder, an organic material, and a solvent.

The organic material contained in the paste is not particularly limited, and it is possible to use at least one polymer material selected from the group consisting of a polyvinyl acetal resin, a cellulose resin, a polyacrylic resin, a polyurethane resin, a polyvinyl acetate resin, and a polyvinyl alcohol resin. The kind of the solvent is not particularly limited, and is, for example, one kind or two or more kinds of butyl acetate, N-methyl-pyrrolidone, toluene, terpineol, and N-methyl-pyrrolidone.

In the wet mixing, a medium can be used, and specifically, a ball mill method, a viscomill mill, or the like can be used. On the other hand, a wet mixing method in which a solvent is not used may be used, and a sand mill method, a high-pressure homogenizer method, a kneader dispersion method, or the like can be used.

The support substrate is not particularly limited as long as it is a support capable of supporting each of the paste layers, and is, for example, a release film having one surface subjected to a release treatment or the like. Specifically, a substrate formed of a polymer material such as polyethylene terephthalate can be used. In a case where each of the paste layers is subjected to a firing step while being held on the substrate, the substrate having heat resistance to a firing temperature may be used.

The applied paste is dried on a hot plate heated to 30° C. or higher and 50° C. or lower to form a positive electrode layer green sheet, a negative electrode layer green sheet, a solid electrolyte layer green sheet, a current collector layer green sheet, an insulating layer green sheet, and/or a protective layer green sheet that has a predetermined shape and thickness on a substrate (for example, a PET film).

Next, each of the green sheets is peeled from the substrate. After the peeling of the green sheet, the green sheets for the respective constituent elements of the battery constituent unit are sequentially laminated in a lamination direction to form a solid-state battery laminate precursor. After the lamination, a solid electrolyte layer, an insulating layer, and/or a protective layer may be provided in a side region of the electrode green sheet by screen printing.

(Firing Step)

In the firing step, the solid-state battery laminate precursor is subjected to firing. Although it is merely an example, the firing is performed by removing organic materials, for example, at 500° C. in a nitrogen gas atmosphere containing oxygen gas or in the atmosphere, and then performing heating, for example, at 550° C. or higher and 5,000° C. or lower in a nitrogen gas atmosphere or in the atmosphere. The firing may be performed while pressurizing the solid-state battery laminate precursor in the lamination direction (in some cases, the lamination direction and a direction perpendicular to the lamination direction).

By performing such firing, a solid-state battery laminate is formed and a desired solid-state battery is finally obtained.

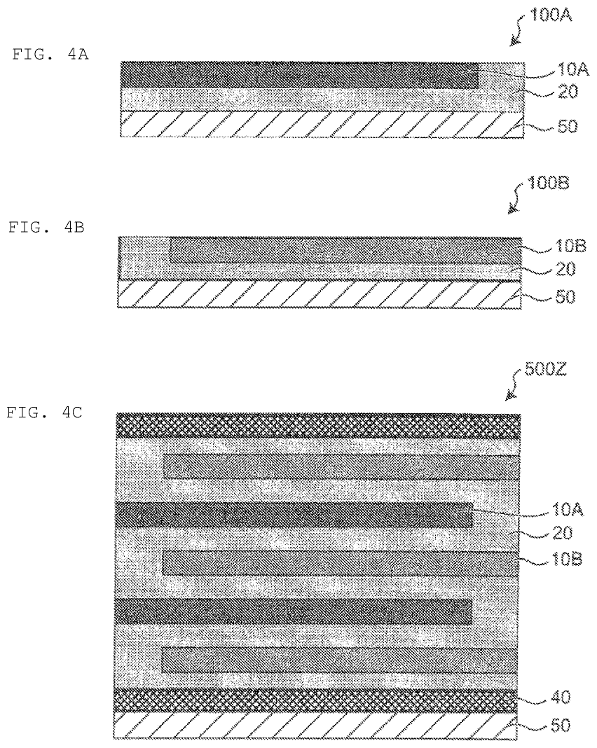

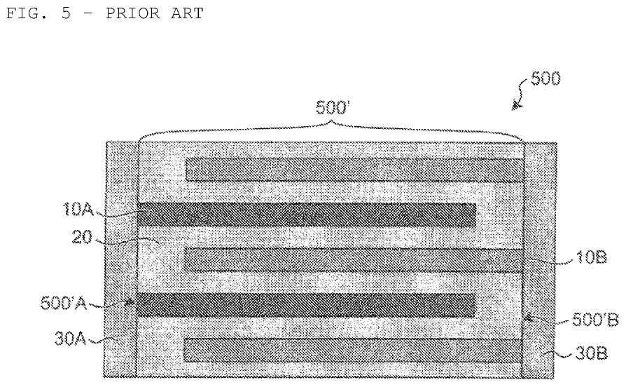

Hereinafter, a method of producing a solid-state battery will be specifically described based on an exemplary aspect illustrated in FIG. 4A to FIG. 4C.

In order to produce a solid-state battery, for example, as described below, a step of forming a positive electrode green sheet 100A, a step of forming a negative electrode green sheet 100B, a step of forming a solid-state battery laminate 500′, and a step of forming each of a positive electrode terminal 30A and a negative electrode terminal 30B are performed.

[Step of Forming Positive Electrode Green Sheet]

First, a solid electrolyte, a solvent, and if necessary, an electrolyte binder or the like are mixed with each other to prepare a paste for a solid electrolyte layer. Subsequently, as illustrated in FIG. 4A, the paste for a solid electrolyte layer is applied onto one surface of a substrate 50 to form a solid electrolyte layer 20. At this time, one end of the solid electrolyte layer 20 is applied so as to be thick to have the same height as that of an electrode layer to be applied later.

Subsequently, a positive electrode active material, a solvent, and if necessary, a positive electrode active material binder or the like are mixed with each other to prepare a paste for a positive electrode layer. Subsequently, the paste for a positive electrode layer is applied onto a surface of the solid electrolyte layer 20 (that is, a portion other than a portion at which the solid electrolyte layer 20 is formed so as to be thick) using a pattern forming method, thereby forming a positive electrode layer 10A. Therefore, a positive electrode layer green sheet 100A in which the solid electrolyte layer 20 and the positive electrode layer 10A are formed is obtained.

[Step of Forming Negative Electrode Green Sheet]

Finally, as illustrated in FIG. 4B, the solid electrolyte layer 20 is formed on one surface of the substrate 50 according to the procedure described above.

Subsequently, a negative electrode active material, a solvent, and if necessary, a negative electrode active material binder or the like are mixed with each other to prepare a paste for a negative electrode layer. Subsequently, the paste for a negative electrode layer is applied onto a surface of the solid electrolyte layer 20 (that is, a portion other than a portion at which the solid electrolyte layer 20 is formed so as to be thick) using a pattern forming method, thereby forming a negative electrode layer 10B. Therefore, a negative electrode layer green sheet 100B in which the solid electrolyte layer 20 and the negative electrode layer 10B are formed is obtained.

[Step of Forming Solid-State Battery Laminate]

First, a protective solid electrolyte, a solvent, and if necessary, a protective binder or the like are mixed with each other to prepare a paste for a protective layer. Alternatively, a protective solid electrolyte, a solvent, an insulating material, and if necessary, a protective binder or the like are mixed with each other to prepare a paste for a protective layer. Subsequently, as illustrated in FIG. 4C, the paste for a protective layer is applied onto one surface of the substrate 50 to form a protective layer 40.

Subsequently, the negative electrode layer green sheet 100B and the positive electrode layer green sheet 100A that are peeled off from the substrate 50 are sequentially and alternately laminated on the protective layer 40. Here, for example, three negative electrode green sheets 100B and two positive electrode layer green sheets 100A are alternately laminated.

Subsequently, the solid electrolyte layer 20 is formed on the negative electrode layer green sheet 100B peeled off from the substrate 50 in the same procedure as the procedure of forming the solid electrolyte layer 20, and the protective layer 40 is formed on the solid electrolyte layer 20 in the same procedure as the procedure of forming the protective layer 40. Subsequently, the lowermost substrate 50 is peeled off to form a solid-state battery laminate precursor 500Z.

Finally, the solid-state battery laminate precursor 500Z is heated. In this case, a heating temperature is set so that a series of layers constituting the solid-state battery laminate precursor 500Z is sintered. Other conditions such as a heating time can be arbitrarily set.

Since a series of layers constituting the solid-state battery laminate precursor 500Z is sintered by the heating treatment, the series of layers is thermally pressure-bonded. Therefore, a solid-state battery laminate 500′ can be preferably integrally formed as a sintered body.

[Step of Forming Each of Positive Electrode Terminal and Negative Electrode Terminal]

For example, a positive electrode terminal is bonded to the solid-state battery laminate using a conductive binder, and a negative electrode terminal is bonded to the solid-state battery laminate using a conductive binder. Therefore, each of the positive electrode terminal and the negative electrode terminal is attached to the solid-state battery laminate, thereby completing a solid-state battery.

(Production of Characteristic Portion in the Present Invention)

The negative electrode terminal in the solid-state battery of the present invention may be formed by any method as long as it is formed of a terminal material that does not react with lithium ions at a potential of −3 V to −2 V with respect to a standard electrode potential. As an example, a raw material paste formed of a terminal material (for example, nickel or the like) that does not react with lithium ions at a potential of −3 V to −2 V with respect to a standard electrode potential may be applied to the substrate, and then, the raw material paste may be heated and cured. As another example, a raw material paste formed of a terminal material that does not react with lithium ions at a potential of −3 V to −2 V with respect to a standard electrode potential and a raw material paste formed of a metallic material (for example, silver or the like) having a conductivity relatively higher than that of the terminal material may be applied to the substrate so as to be laminated, and then, the raw material paste may be heated and cured. In addition, as still another example, a raw material paste formed of particles may be applied to the substrate so that the terminal material covers surfaces of metallic material particles having a conductivity relatively higher than that of the terminal material that does not react with lithium ions at a potential of −3 V to −2 V with respect to a standard electrode potential, and then, the raw material paste may be heated and cured.

### EXAMPLES

In order to confirm the effects of the present invention, the following verification tests were performed.

### Example: Solid-State Battery Using Nickel for External Terminal

[Production of External Terminal Evaluation Cell]

A sintered body (diameter: 15 mm, thickness: about 0.3 mm) for a solid electrolyte was produced, a nickel paste as an external terminal material was applied onto one surface of the sintered body so that a diameter was 6 mm, and the nickel paste was heated and cured on a hot plate at 150° C. for 10 minutes, thereby forming an external terminal (nickel electrode: working electrode). Thereafter, metallic lithium having a diameter of 10 mm was thermally pressure-bonded to the other surface of the solid electrolyte sintered body at 100° C. to form a counter electrode. In the same procedure, metallic lithium (diameter: 1 mm) was pressure-bonded onto a surface on which a nickel terminal of the solid electrolyte sintered body was formed so as to be in contact with the nickel terminal to form a reference electrode, thereby producing an external terminal evaluation cell.

[Linear Sweep Voltammetry Evaluation of Terminal Material]

The produced cell was subjected to linear sweep voltammetry evaluation under the following conditions.
Working electrode: nickel (electrolysis area: diameter of 6 mm)
Reference electrode: lithium (diameter of 1 mm)
Counter electrode: lithium (diameter of 10 mm)
Scanning potential: 3 V to 0.05 V (0.05 V to −3 V vs. SHE)
Sweep rate: 0.2 mV/sec
Temperature: 25° C.

### Comparative Example: Solid-State Battery Using Silver for External Terminal

As Comparative Example, an external terminal evaluation cell was produced and the same evaluation was performed in the same manner as that of Example except that a silver paste was used for an external terminal.

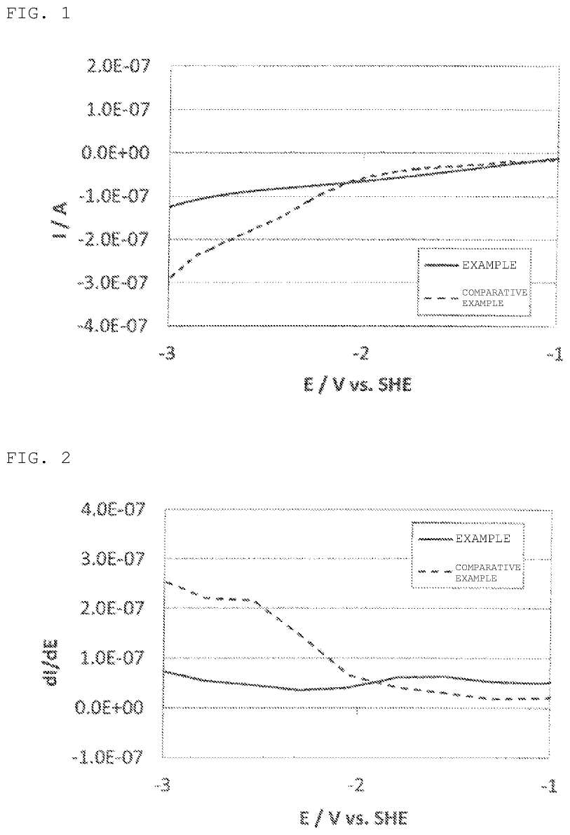

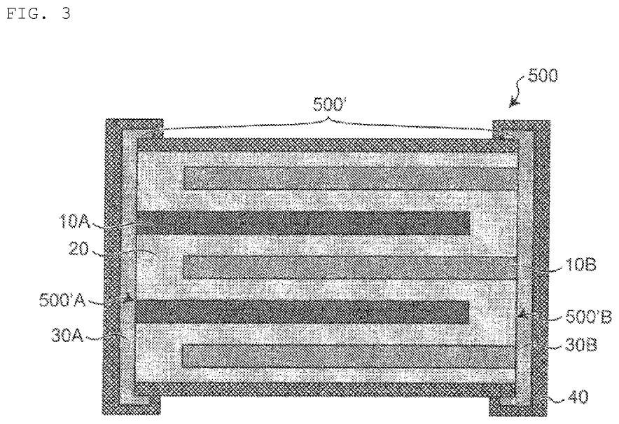

In the linear sweep voltammetry evaluation in each of Example and Comparative Example, a reduction wave obtained by sweeping the potential with respect to the standard electrode potential in a negative direction is illustrated in FIG. 1. In addition, a differential curve of a differential value of the current value in each of Example and Comparative Example illustrated in FIG. 1 calculated by the following method using a potential as a parameter is illustrated in FIG. 2.

[Method of Calculating Differential Value Using Potential as Parameter]

The differential value of each of the reduction current values obtained by the measurement was calculated according to Equation 1 by Excel (registered trademark, Microsoft Corporation) as computer software. Here, ΔV in Equation 1 was 0.5 V, and a differential value for each potential of 0.25 V was calculated. An average of the differential values calculated at −2 V to −1 V with respect to the standard electrode potential and an average of the differential values calculated at −3 V to −2 V with respect to the standard electrode potential were calculated.

In the case of the nickel terminal material in Example, a specific reduction current peak was not confirmed at any potential with respect to the standard electrode potential, and only the reduction current of the capacitor component was confirmed. That is, it was found that an irreversible side reaction between the lithium ions and the nickel terminal material did not occur (see FIG. 1). On the other hand, in the case of the silver terminal material in Comparative Example, a specific reduction current peak (that is, a drastic change in slope in the current curve) was confirmed around a potential below −2 V with respect to the standard electrode potential, and it was found that an irreversible side reaction between the lithium ions and the silver terminal material occurred (see FIG. 1).

In addition, in the case of the nickel terminal material in Example, it was found that a change in differential value in a potential range of −3 V to −2 V to the differential value in a potential range of −2 V to −1 V with respect to the standard electrode potential was small, and an irreversible side reaction between the lithium ions and the nickel terminal material did not occur (see FIG. 2). On the other hand, in the case of the silver terminal material in Comparative Example, it was found that a change in differential value was large, and there was a drastic change in slope in the current curve. That is, it was found that an irreversible side reaction between the lithium ions and the silver terminal material occurred (see FIG. 2).

Here, as for the differential value of the current value obtained using the potential with respect to the standard electrode potential as a parameter in the differential curve illustrated in FIG. 2, a ratio of the average of the differential values at −3 V to −2 V to the average of the differential values at −2 V to −1 V is 0.8 when the nickel terminal material was used and 6.7 when the silver terminal material was used.

Although the embodiments of the present invention have been described above, the embodiments of the present invention are merely typical examples. Therefore, those skilled in the art will easily understand that the present invention is not limited thereto, and various embodiments are conceivable without changing the gist of the present invention.

The solid-state battery of the present invention can be used in various fields where electric storage is required. Although this is just one example, the solid-state battery of the present invention can be used in electricity, information, and communication fields using electric and electronic equipment (for example, electric and electronic equipment fields or a mobile equipment field including a mobile phone, a smartphone, a laptop computer, a digital camera, an activity meter, an arm computer, an electronic paper, and a small electronic device such as an RFID tag, a card-type electronic money, or a smart watch), home and small industrial applications (for example, power tool, golf cart, and home, nursing, and industrial robot fields), large industrial applications (for example, forklift, elevator, and harbor crane fields), transportation system fields (for example, hybrid vehicle, electric vehicle, bus, train, electric powder assist bicycle, and electric motorcycle fields), power system applications (for example, various fields of powder generation, road conditioner, smart grid, and general household electric storage systems), medical applications (medical equipment fields such as earphone hearing aids), pharmaceutical applications (fields such as dose management systems), IoT fields, space and deep see applications (for example, space probe and submersible research vessel fields), and the like.

### DESCRIPTION OF REFERENCE SYMBOLS

10: Electrode layer
10A: Positive electrode layer
10B: Negative electrode layer
20: Solid electrolyte layer
30: Terminal
30A: Positive electrode terminal
30B: Negative electrode terminal
40: Protective layer
50: Support substrate (substrate)
100: Green sheet
100A: Positive electrode green sheet
100B: Negative electrode green sheet
500Z: Solid-state battery laminate precursor
500′: Solid-state battery laminate
500′A: Positive electrode side end surface
500′B: Negative electrode side end surface
500: Solid-state battery

1. A lithium ion solid-state battery comprising:
a solid-state battery laminate having at least one battery constituent unit in a lamination direction, the battery constituent unit including a positive electrode layer, a negative electrode layer, and a solid electrolyte layer interposed between the positive electrode layer and the negative electrode layer;
a positive electrode terminal on a surface of the solid-state battery laminate and electrically connected to the positive electrode layer; and
a negative electrode terminal on the surface of the solid-state battery laminate and electrically connected to the negative electrode layer,
wherein the negative electrode layer comprises a negative electrode active material configured to be charged and discharged at a potential of −2 V or less with respect to a standard electrode potential, and
the negative electrode terminal comprises a terminal material that does not react with the lithium ions at a potential of −3 V to −2 V with respect to the standard electrode potential.

2. The lithium ion solid-state battery according to claim 1, wherein a ratio of an average of first differential values at −3 V to −2 V to an average of second differential values at −2 V to −1 V is 8.0 or less, the first and second differential values being a differential of a current value obtained by linear sweep voltammetry measurement using the negative electrode terminal and lithium as a working electrode and a reference electrode, respectively, and using a potential with respect to the standard electrode potential as a parameter.

3. The lithium ion solid-state battery according to claim 2, wherein the ratio of the average of the first differential values at −3 V to −2 V to the average of the second differential values at −2 V to −1 V is 6.0 or less.

4. The lithium ion solid-state battery according to claim 2, wherein the ratio of the average of the first differential values at −3 V to −2 V to the average of the second differential values at −2 V to −1 V is 4.0 or less.

5. The lithium ion solid-state battery according to claim 2, wherein the ratio of the average of the first differential values at −3 V to −2 V to the average of the second differential values at −2 V to −1 V is 2.0 or less.

6. The lithium ion solid-state battery according to claim 1, wherein the negative electrode terminal further comprises a metallic material having a conductivity higher than that of the terminal material, and the terminal material is positioned on a side of the negative electrode terminal that is in contact with the solid-state battery laminate.

7. The lithium ion solid-state battery according to claim 1, wherein the negative electrode terminal further comprises metallic material particles having a conductivity higher than that of the terminal material, and the terminal material is on surfaces of the metallic material particles.

8. The lithium ion solid-state battery according to claim 1, wherein the terminal material is at least one material selected from nickel, copper, manganese, cobalt, iron, titanium, and chromium.

9. The lithium ion solid-state battery according to claim 8, wherein the negative electrode active material is graphite and/or a lithium alloy.

10. The lithium ion solid-state battery according to claim 1, wherein the negative electrode active material is graphite and/or a lithium alloy.

11. The lithium ion solid-state battery according to claim 8, wherein the solid electrolyte layer comprises at least two materials selected from lithium, boron, silicon, phosphorus, and oxygen.

12. The lithium ion solid-state battery according to claim 1, wherein the solid electrolyte layer comprises at least two materials selected from lithium, boron, silicon, phosphorus, and oxygen.
